(19) United States
(12) Patent Application Publication
(10) Pub. No.: US 2019/0152312 A1
(43) Pub. Date: May 23, 2019

(54) HIGH-PRESSURE VESSEL FOR VEHICLE

(71) Applicant: DONG HEE INDUSTRIAL CO., LTD., Ulsan (KR)

(72) Inventors: Kyun Bum PARK, Hwaseong-si (KR); Hyung Joo CHO, Gwangmyeong-si (KR); Lee Park KIM, Yongin-si (KR); Tae Hong KYE, Suwon-si (KR)

(73) Assignee: DONG HEE INDUSTRIAL CO., LTD., Ulsan (KR)

(21) Appl. No.: 16/251,375

(22) Filed: Jan. 18, 2019

Related U.S. Application Data
(63) Continuation of application No. PCT/KR2017/007888, filed on Jul. 21, 2017.

(30) Foreign Application Priority Data
Jul. 21, 2016 (KR) 10-2016-0092386

(51) Int. Cl. B60K 15/03; F17C 1/16; F17C 13/04

(52) U.S. Cl. CPC B60K 15/03006; F17C 2270/0184; F17C 13/04; B60K 2015/03039; B60K 2015/03493; F17C 2201/0109; F17C 2203/0604; F17C 2203/0663; F17C 2203/066; F17C 2203/0619; F17C 2205/0305; F17C 2205/0323; F17C 2209/221; F17C 2209/2118; F17C 1/16

(57) ABSTRACT

A structure for a high-pressure vessel is provided to inhibit a gap between a plastic liner and a plastic sealing member due to the plastic sealing member being combined with the plastic liner by thermal bonding, thereby preventing the leakage of high-pressure gas to the gap between the plastic liner and the plastic sealing member. In addition, as the plastic liner and the plastic sealing member made of the same materials are combined with each other by the thermal bonding, use of the conventional lower fastening member is unnecessary, and further, use of a rubber sealing member for maintaining airtightness is unnecessary. Thus productivity via reduction in the number of components, a weight, a cost, and man-hours is improved.

### CROSS-REFERENCE TO RELATED APPLICATIONS

This application is a continuation of International Application No. PCT/KR2017/007888, filed on Jul. 21, 2017, which claims priority to and the benefit of Korean Patent Application No. 10-2016-0092386, filed on Jul. 21, 2016, the entirety of each of which are hereby incorporated by reference.

### FIELD

The present disclosure relates generally to a high-pressure vessel for a vehicle.

### BACKGROUND

The statements in this section merely provide background information related to the present disclosure and may not constitute prior art.

Generally, a compressed natural gas (CNG) vehicle or a hydrogen fuel cell vehicle includes a high-pressure vessel mounted therein, by which a fuel in an evaporated state is high-pressurized and stored.

The high-pressure vessel includes a plastic liner, a composite material layer covering the plastic liner, and a metallic nozzle boss. For weight reduction, the plastic liner is made of a plastic material such as high-density polyethylene, polypropylene, or polyester resin, the composite material layer made by mixing carbon fiber or glass fiber with polymer resin such as epoxy resin for strength maintenance is combined with the plastic liner so as to cover a surface of the plastic liner, and the nozzle boss is manufactured of a metallic material so as to be securely combined with a regulator or a valve (hereinbelow, referred to as a valve), which is manufactured of the metallic material.

Meanwhile, since the plastic liner and the metallic nozzle boss are made of different materials, an adhesive cannot be used so as to combine the plastic liner with the metallic nozzle. Accordingly, maintaining airtightness between the plastic liner and the metallic nozzle boss is an important issue determining the performance and stability of the high-pressure vessel.

Pressure in the high-pressure vessel is normally a high pressure of 700 ba, and when the airtightness between the plastic liner and the metallic nozzle boss is lowered, a high-pressure gas stored in the high-pressure vessel leaks to outside, and particularly, the nozzle boss is separated from the plastic liner by the high-pressure gas, which may cause an accident.

As shown in FIG. 1, according to a conventional high-pressure vessel showing a portion on which the plastic liner and the nozzle boss are combined with each other, the plastic liner 1 and the metallic nozzle boss 2 are configured to be combined with each other by injection molding. That is, when the plastic liner 1 is injection-molded after the metallic nozzle boss 2 manufactured previously is put in an injection mold, the plastic liner 1 and the metallic nozzle boss 2 are combined with each other.

Due to the characteristics of an injection combination, the plastic liner 1 and the metallic nozzle boss 2, which are made of different materials, cannot be perfectly combined with each other and accordingly, a minute gap between the plastic liner 1 and the metallic nozzle boss 2 occurs.

When there is a gap between the plastic liner 1 and the metallic nozzle boss 2, the high-pressure gas in the vessel leaks through the gap between the plastic liner 1 and the metallic nozzle boss 2 to the outside.

Accordingly, according to the conventional high-pressure vessel, a lower fastening member 3, which is additionally manufactured, is configured to be combined with the metallic nozzle boss 2 so as to remove the gap between the plastic liner 1 and the metallic nozzle boss 2.

The lower fastening member 3 functions to press an end part of the plastic liner 1 toward the metallic nozzle boss 2 so as to bring the plastic liner into close contact with the metallic nozzle boss.

The lower fastening member 3 is made of a metallic material so as to be securely fastened to the metallic nozzle boss 2 and is normally screwed to the metallic nozzle boss.

However, since the plastic liner 1 and the metallic lower fastening member 3 are respectively made of different materials, a gap between the plastic liner 1 and the lower fastening member 3 occurs, and the high-pressure gas in the vessel leaks through the gap between the plastic liner 1 and the lower fastening member 3 and through the gap between the plastic liner 1 and the metallic nozzle boss 2 to an outside of the plastic liner 1.

To prevent this, a rubber sealing member 4 (an O-ring) may be combined with the lower fastening member 3 so as to remove the gap between the plastic liner 1 and the lower fastening member 3.

However, we have discovered that when the rubber sealing member 4 is continuously pressurized by the high-pressure gas, durability thereof lowers rapidly and accordingly, the leak of the high-pressure gas to the outside cannot be securely inhibited or prevented.

In addition, the life of the rubber sealing member 4 is normally a short period of four to five years, and is further shortened particularly when pressure of the high-pressure gas is continuously applied to the rubber sealing member. In addition, since the life of a vehicle having the high-pressure vessel mounted therein is longer than the life of the sealing member 4, the high-pressure vessel is required to be periodically replaced due to the durability reduction of the sealing member 4.

That is, in a structure of the conventional high-pressure vessel, the lower fastening member 3 and the sealing member 4 are used to remove the gap between the plastic liner 1 and the metallic nozzle boss 2, which are made of different materials, whereby the number of components, a weight, a cost, and man-hours are increased. Particularly, when the durability of the sealing member 4 lowers since the sealing member 4 is made of a rubber material, which has short life, the high-pressure gas in the vessel still leaks to the outside and due to the sealing member 4 having the lowered durability, the high-pressure vessel is required to be periodically replaced.

Reference numerals 5 and 6 shown in FIG. 1, which are not described, are the composite material layer and an upper fastening member, respectively.

As a related conventional art, there is Korean Utility Model Registration No. 20-0372069.

The foregoing is intended merely to aid in the understanding of the background of the present disclosure, and is not intended to mean that the present disclosure falls within the purview of the related art that is already known to those skilled in the art.

### SUMMARY

The present disclosure provides a high-pressure vessel for a vehicle, whereby an airtightness structure between a plastic liner and a metallic nozzle boss is improved such that high-pressure gas in the vessel is inhibited or prevented from leaking to outside of the plastic liner.

The present disclosure provides a high-pressure vessel for a vehicle, and the high-pressure vessel includes: a plastic liner including a through hole provided thereon; a plastic sealing member including a first portion positioned in the through hole and a second portion configured to overlap with the plastic liner, wherein the second portion overlapping with the plastic liner is combined with the plastic liner by thermal bonding; and a metallic nozzle boss combined with the plastic sealing member and configured to cover the second portion of the plastic sealing member.

The plastic liner may be made of a plastic resin by blow molding and be combined with the plastic sealing member by the thermal bonding during the blow molding of the plastic liner.

The first portion of the plastic sealing member may form a cylindrical part liner and protrude in an outer side direction of the plastic liner; and the second portion of the plastic sealing member forms a wing part in a circular plate shape provided to bend so as to correspond a shape of the plastic liner while extending in a radial direction from an end of the cylindrical part and a predetermined section of which may be combined with an outer surface of the plastic liner by the thermal bonding.

The wing part may include an inclined part provided on an end part thereof so as to incline toward a protruding direction of the cylindrical part, wherein the inclined part of the wing part may be provided to have the same shape as an inclined part of the plastic liner, and the inclined part of the wing part and the inclined part of the plastic liner may be combined with each other by the thermal bonding.

The metallic nozzle boss may include: a flange part being combined with the wing part of the plastic sealing member so as to cover the wing part, and a boss part extending along a longitudinal direction of the cylindrical part of the plastic sealing member from the flange part, wherein the boss part may include threads provided on an inner circumferential surface thereof so as to be engaged with a valve.

The flange part of the metallic nozzle boss may be provided to be longer than the wing part of the plastic sealing member so as to be combined with the wing part such that the flange part entirely covers the wing part.

The cylindrical part of the plastic sealing member may be provided to extend up to the threads provided on the boss part of the metallic nozzle boss such that the cylindrical part and the threads are connected to each other.

The high-pressure vessel may further include: a composite material layer combined with the plastic liner and the metallic nozzle boss so as to cover the plastic liner and the metallic nozzle boss, and the valve screwed to the boss part of the metallic nozzle boss by being inserted thereinto.

A front end of the valve may be provided to be inserted to an inner side of the cylindrical part of the plastic sealing member, and a front end part of the valve positioned on the inner side of the cylindrical part may include multiple valve O-rings combined thereon so as to maintain airtightness between the valve and the cylindrical part.

The plastic liner and the plastic sealing member may be combined with each other only by the thermal bonding without additionally including a fastening member and a rubber sealing member.

The present disclosure has a structure in which a gap does not occur between the plastic liner and the plastic sealing member due to the plastic sealing member being combined with the plastic liner by thermal bonding, thereby completely blocking the leakage of high-pressure gas to a gap between the plastic liner and the plastic sealing member.

In addition, as the plastic liner and the plastic sealing member made of the same materials are combined with each other by the thermal bonding, use of the conventional lower fastening member is unnecessary and further, use of a rubber sealing member for maintaining airtightness is unnecessary, whereby productivity via reduction in the number of components, a weight, a cost, and man-hours is improved.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a longitudinal sectional view showing a combined portion of a plastic liner with a metallic nozzle boss in a conventional high-pressure vessel;

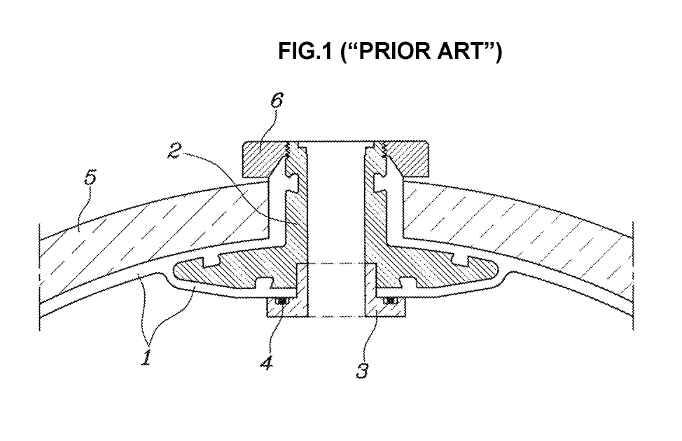

FIG. 2 is a perspective view of the high-pressure vessel according to the present disclosure;

FIG. 3 is an exploded perspective view of FIG. 2;

FIG. 4 is a longitudinal sectional view of FIG. 2; and

FIG. 5 is an enlarged view of a combined portion of a metallic nozzle boss in FIG. 4.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Hereinbelow, a high-pressure vessel for a vehicle for a vehicle according to an exemplary form of the present disclosure will be described in detail with reference to the accompanying drawings.

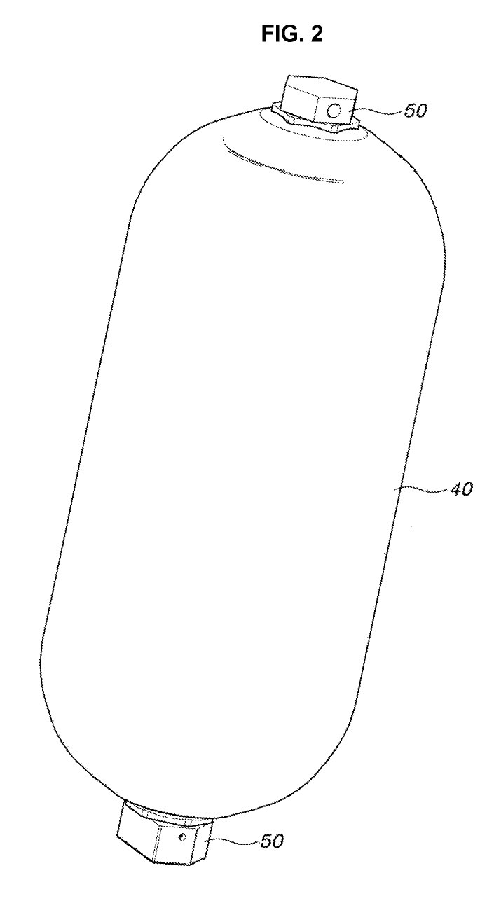

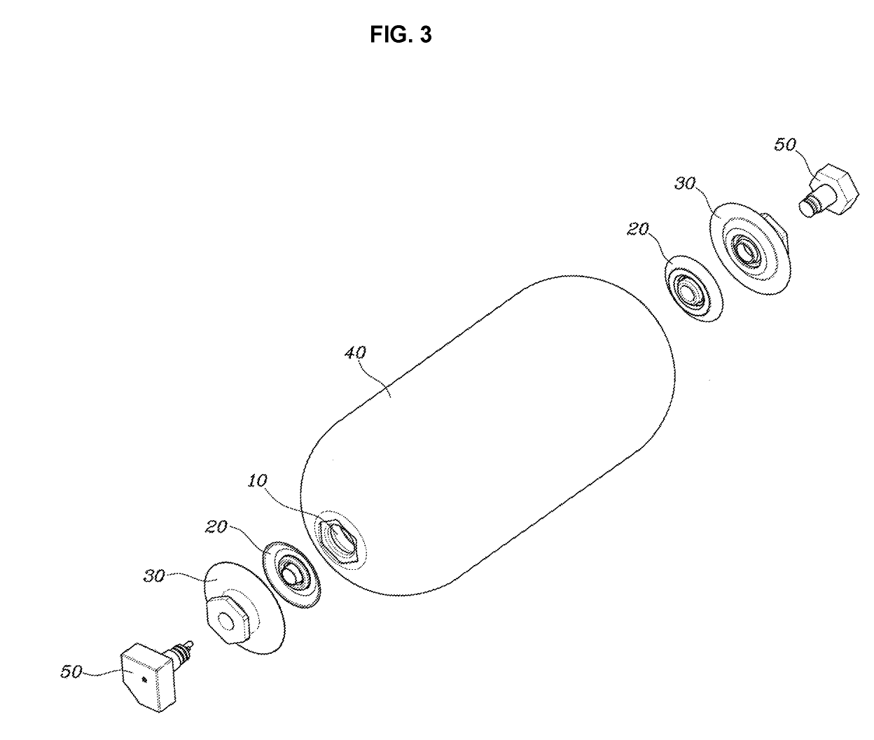

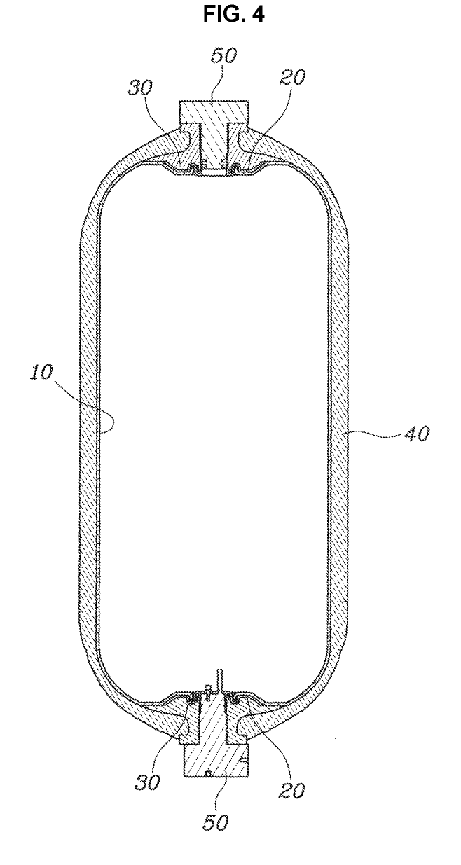

As shown in FIGS. 2 to 5, the high-pressure vessel for a vehicle in one form of the present disclosure includes: a plastic liner 10 including a through hole 11 provided thereon; a plastic sealing member 20, a portion of which is positioned in the through hole 11 and a remaining portion of which overlaps with the plastic liner 10, wherein the portion overlapping with the plastic liner 10 is combined with the plastic liner 10 by thermal bonding; a metallic nozzle boss 30 combined with the plastic sealing member 20 so as to cover the portion of the plastic sealing member 20 overlapping with the plastic liner 10; a composite material layer 40 combined with the plastic liner 10 and the metallic nozzle boss 30 so as to cover the plastic liner and the metallic nozzle boss; and a valve 50 screwed to the metallic nozzle boss 30.

For weight reduction, the plastic liner 10 is integrally manufactured of a plastic material such as high-density polyethylene, polypropylene, or polyester resin by blow molding.

In one form, a material of the plastic sealing member 20 is the same material as a material of the plastic liner 10 and is manufactured by injection molding, and during the blow molding of the plastic liner 10, the plastic sealing member 20 is combined with the plastic liner 10 by the thermal bonding.

When the plastic liner 10 and the plastic sealing member 20, which are made of the same materials, are combined with each other by the thermal bonding, the plastic liner 10 and the plastic sealing member 20 are completely combined with each other. Accordingly, high-pressure gas can be prevented from leaking to the gap between the plastic liner 10 and the plastic sealing member 20.

In addition, as the plastic liner 10 and the plastic sealing member 20, which are made of the same materials, are combined with each other by the thermal bonding, use of a conventional lower fastening member 3 is unnecessary, and further, use of a rubber sealing member 4 for maintaining airtightness is unnecessary, whereby productivity via reduction in the number of components, a weight, a cost, and man-hours is improved.

The metallic nozzle boss 30 is made of a metal, which is different from materials of the plastic liner 10 and the plastic sealing member 20, so as to be securely combined with the valve 50 made of a metal.

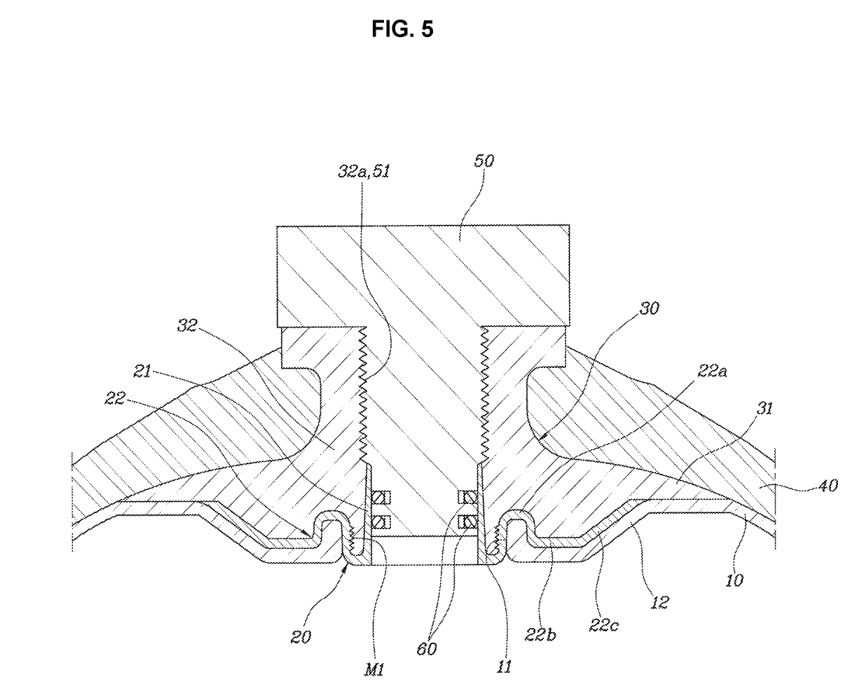

As shown in FIG. 5, the metallic nozzle boss 30 is screwed to the plastic sealing member 20 (M1), and in this case, a major portion of a lower surface of the metallic nozzle boss, which faces the plastic liner 10, is in contact with the plastic sealing member 20 and only some portion thereof is in contact with the plastic liner 10.

Though minute gaps may occur between the metallic nozzle boss 30 and the plastic liner 10, which are made of different materials, and between the metallic nozzle boss 30 and the plastic sealing member 20, which are made of different materials, the gaps do not directly communicate with an inner part of the high-pressure vessel.

That is, the gap between the metallic nozzle boss 30 and the plastic liner 10 and the gap between the metallic nozzle boss 30 and the plastic sealing member 20 communicate with the inner part of the high-pressure vessel only by a gap between the plastic liner 10 and the plastic sealing member 20.

However, according to one form of the present disclosure, the plastic liner 10 and the plastic sealing member 20, which are made of the same materials, are completely combined with each other by the thermal bonding so as not to have the gap. Accordingly the gap between the metallic nozzle boss 30 and the plastic liner 10 and the gap between the metallic nozzle boss 30 and the plastic sealing member 20 are blocked by the plastic liner 10 and the plastic sealing member 20 combined with each other by the thermal bonding such that the gaps do not directly communicate with the inner part of the high-pressure vessel. Accordingly, the high-pressure gas stored in the high-pressure vessel is fundamentally prevented from leaking to the outside.

The composite material layer 40 made by mixing carbon fiber or glass fiber with polymer resin such as epoxy resin for strength maintenance is combined with the plastic liner 10 and the nozzle boss 30 so as to cover surfaces of the plastic liner 10 and the nozzle boss 30.

The valve 50 manufactured of a metallic material is combined with the metallic nozzle boss 50 by being screwed thereto.

The plastic sealing member 20 includes a cylindrical part 21 positioned in the through hole 11 of the plastic liner 10 and protruding in an outer side direction of the plastic liner 10; and a wing part 22 of a circular plate shape provided to bend so as to correspond a shape of the plastic liner 10 while extending in a radial direction from an end of the cylindrical part 21 and a predetermined section of which is combined with an outer surface of the plastic liner 10 by the thermal bonding.

The wing part 22 includes a curved part 22a formed curvedly so as to have a wavy shape, a horizontal part 22b extending in a horizontal direction, and an inclined part 22c provided on the horizontal part 22b to incline toward a protruding direction of the cylindrical part 21.

The inclined part 22c of the wing part 22 is provided to have the same shape as an inclined part 12 of the plastic liner 10, and the inclined part 22c and the inclined part 12 are combined with each other by the thermal bonding.

As mentioned before, the plastic liner 10 is blow molded and is combined with the plastic sealing member 20 by the thermal bonding during the blow molding. A combined portion of the plastic sealing member 20 with the plastic liner 10 by the thermal bonding is the wing part 22, wherein the curved part 22a of the wing part 22 is weak in a combining force due to a curved shape thereof and the horizontal part 22b, which is weak in a support force, may be deformed by a pressure occurring during the thermal bonding. Accordingly, the inclined part 22c that is strong in a combining force and can sufficiently bear the pressure occurring during the thermal bonding may be combined with the inclined part 12 of the plastic liner 10 by the thermal bonding.

The metallic nozzle boss 30 includes a flange part 31 being combined with the wing part 22 of the plastic sealing member 20 so as to cover the wing part 22 thereof; and a boss part 32 extending along a longitudinal direction of the cylindrical part 21 of the plastic sealing member 20 from the flange part 31, wherein the boss part 32 includes threads 32a provided on an inner circumferential surface thereof so as to be engaged with the valve 50 and accordingly, is engaged with threads 51 of the valve 50.

The flange part 31 of the metallic nozzle boss 30 is provided to be longer than the wing part 22 of the plastic sealing member 20 so as to be combined with the wing part 22 such that the flange part completely covers the wing part. Accordingly, the wing part 22 of the plastic sealing member 20 is completely brought into close contact with the plastic liner 10 by an applying force of the flange part 31 of the metallic nozzle boss 30 so as to maintain a more stable combining force with the plastic liner and sufficiently bear a pressure of the high-pressure gas stored in the vessel.

In one form, a length of the flange part 31 is configured to be roughly 30% to 80% longer than a length of the wing part 22, but is not limited thereto.

In another form, the cylindrical part 21 of the plastic sealing member 20 is provided to extend up to the threads 32a provided on the boss part 32 of the metallic nozzle boss 30 such that the cylindrical part 21 and the threads 32a are combined with each other.

That is, a gap between an end of the cylindrical part 21 and the threads 32a is removed so as to maintain a secure combining force of the plastic sealing member 20 and particularly, to inhibit or prevent a gas leak at the maximum.

The valve 50 is inserted into the boss part 32 to be screwed to the boss part 32. In this case, a front end of the valve 50 is provided to be inserted to an inner side of the cylindrical part 21 of the plastic sealing member 20, and a front end part of the valve 50 positioned on the inner side of the cylindrical part 21 includes multiple valve O-rings 60 combined thereon so as to maintain airtightness between the valve and the cylindrical part 21.

Each of the valve O-rings 60 is a rubber in a material thereof and prevents the high-pressure gas in the vessel from leaking through a gap between the cylindrical part 21 of the plastic sealing member 20 and the valve 50. When durability of the valve O-ring decreases due to use thereof, only the valve O-ring 60 is desired to be replaced with a new valve O-ring after separating the valve 50 from the boss part 32.

According to the form described above, the present disclosure has a structure in which a gap does not occur between the plastic liner 10 and the plastic sealing member 20 due to the plastic sealing member 20 being combined with the plastic liner 10 by thermal bonding, thereby blocking the leakage of high-pressure gas to a gap between the plastic liner 10 and the plastic sealing member 20.

In addition, as the plastic liner 10 and the plastic sealing member 20 made of the same materials are combined with each other by the thermal bonding, use of the conventional lower fastening member 3 is unnecessary, and further, use of the rubber sealing member 4 for maintaining the airtightness is unnecessary, whereby the productivity enhancement via the reduction in the number of components, a weight, a cost, and man-hours is promoted.

Although the exemplary forms of the present disclosure has been described for illustrative purposes, those skilled in the art will appreciate that various modifications, additions and substitutions are possible, without departing from the scope and spirit of the present disclosure.

### DESCRIPTION OF THE REFERENCE NUMERALS IN THE DRAWINGS

| | |
|---|---|
| 10: Plastic liner | 11: Through hole |
| 12: Inclined part | 20: Plastic sealing member |
| 21: Cylindrical part | 22: Wing part |
| 30: Metallic nozzle boss | 31: Flange part |
| 32: Boss part | 40: Composite material layer |
| 50: Valve | 60: Valve O-ring |

What is claimed is:

1. A high-pressure vessel for a vehicle, the high-pressure vessel comprising:
a plastic liner including a through hole provided thereon;
a plastic sealing member including a first portion positioned in the through hole and a second portion configured to overlap with the plastic liner, wherein the second portion overlapping with the plastic liner is combined with the plastic liner by thermal bonding; and
a metallic nozzle boss combined with the plastic sealing member and configured to cover the second portion of the plastic sealing member.

2. The high-pressure vessel of claim 1, wherein the plastic liner is made of a plastic resin by blow molding and is combined with the plastic sealing member by the thermal bonding during the blow molding of the plastic liner.

3. The high-pressure vessel of claim 1, wherein the first portion of the plastic sealing member forms a cylindrical part and protrudes in an outer side direction of the plastic liner; and
wherein the second portion of the plastic sealing member forms a wing part in a circular plate shape provided to bend so as to correspond a shape of the plastic liner while extending in a radial direction from an end of the cylindrical part and a predetermined section of which is combined with an outer surface of the plastic liner by the thermal bonding.

4. The high-pressure vessel of claim 3, wherein the wing part includes an inclined part provided on an end part thereof so as to incline toward a protruding direction of the cylindrical part,
wherein the inclined part of the wing part is provided to have the same shape as an inclined part of the plastic liner, and
the inclined part of the wing part and the inclined part of the plastic liner are combined with each other by the thermal bonding.

5. The high-pressure vessel of claim 3, wherein the metallic nozzle boss includes:
a flange part being combined with the wing part of the plastic sealing member so as to cover the wing part, and
a boss part extending along a longitudinal direction of the cylindrical part of the plastic sealing member from the flange part,
wherein the boss part includes threads provided on an inner circumferential surface thereof so as to be engaged with a valve.

6. The high-pressure vessel of claim 5, wherein the flange part of the metallic nozzle boss is provided to be longer than the wing part of the plastic sealing member so as to be combined with the wing part such that the flange part entirely covers the wing part.

7. The high-pressure vessel of claim 5, wherein the cylindrical part of the plastic sealing member is provided to extend up to the threads provided on the boss part of the metallic nozzle boss such that the cylindrical part and the threads are connected to each other.

8. The high-pressure vessel of claim 5, further comprising:
a composite material layer combined with the plastic liner and the metallic nozzle boss so as to cover the plastic liner and the metallic nozzle boss, and
the valve screwed to the boss part of the metallic nozzle boss by being inserted thereinto.

9. The high-pressure vessel of claim 8, wherein a front end of the valve is provided to be inserted to an inner side of the cylindrical part of the plastic sealing member, and a front end part of the valve positioned on the inner side of the cylindrical part includes multiple valve O-rings combined thereon so as to maintain airtightness between the valve and the cylindrical part.

10. The high-pressure vessel of claim 1, wherein the plastic liner and the plastic sealing member are combined with each other only by the thermal bonding without additionally including a fastening member and a rubber sealing member.
